(19) United States
(12) Patent Application Publication
(10) Pub. No.: US 2019/0129609 A1
(43) Pub. Date: May 2, 2019

(54) ELECTRONIC APPARATUS

(71) Applicant: KYOCERA CORPORATION, Kyoto (JP)

(72) Inventors: Isao MASUIKE, Tokyo (JP); Yasuhiro UENO, Yokohama-shi (JP); Shigeki TANABE, Yokohama-shi (JP); Hideki MORITA, Yokohama-shi (JP); Koutaro YAMAUCHI, Yokohama-shi (JP); Manabu SAKUMA, Yokohama-shi (JP); Kenji SHIMADA, Yokohama-shi (JP)

(21) Appl. No.: 16/171,898

(22) Filed: Oct. 26, 2018

(30) Foreign Application Priority Data
Oct. 30, 2017 (JP) 2017-209436

(51) Int. Cl. G06F 3/0488; G06F 3/0482; G06F 21/32; G06F 21/84; G06K 9/00; G06F 3/0485; G06F 3/0486

(52) U.S. Cl. CPC G06F 3/04883; G06F 3/0482; G06F 21/32; G06F 2221/2149; G06K 9/00087; G06F 3/0485; G06F 3/0486; G06F 21/84

(57) ABSTRACT

An electronic apparatus comprises a display configured to display at least one icon, a fingerprint sensor configured to scan fingerprint information, a touch sensor configured to detect contact of a finger, and a controller configured to execute a function of a certain icon of the at least one icon. The controller executes the function of the certain icon based on the scanned fingerprint information and registered fingerprint information that is registered in advance if movement of a finger toward the certain icon is detected by at least one of the touch sensor and the fingerprint sensor.

### CROSS-REFERENCE TO RELATED APPLICATION

The present application claims priority under 35 U.S.C. § 119 to Japanese Patent Application No. 2017-209436, filed on Oct. 30, 2017, entitled “ELECTRONIC APPARATUS”. The content of which is incorporated by reference herein in its entirety.

### FIELD

Embodiments of the present disclosure relate generally to an electronic apparatus.

### BACKGROUND

Various technologies have been proposed concerning an electronic apparatus.

### SUMMARY

An electronic apparatus is disclosed. In one embodiment, an electronic apparatus comprises a display configured to display at least one icon, a fingerprint sensor configured to scan fingerprint information, a touch sensor configured to detect contact of a finger, and a controller configured to execute a function of a certain icon of the at least one icon. The controller executes the function of the certain icon based on the scanned fingerprint information and registered fingerprint information that is registered in advance if movement of a finger toward the certain icon is detected by at least one of the touch sensor and the fingerprint sensor.

### BRIEF DESCRIPTION OF THE DRAWINGS

FIG. 1 illustrates a perspective view showing one example of external appearance of an electronic apparatus.

FIG. 2 illustrates a back view showing one example of external appearance of the electronic apparatus.

FIG. 3 illustrates a block diagram showing one example of configuration of the electronic apparatus.

FIG. 4 illustrates a view showing one example of display of the electronic apparatus.

FIG. 5 illustrates a view showing one example of display of the electronic apparatus.

FIG. 6 illustrates a flowchart showing one example of operation of the electronic apparatus.

FIG. 7 illustrates a view showing one example of operation performed on the electronic apparatus.

FIG. 8 illustrates a view showing one example of operation performed on the electronic apparatus.

FIG. 9 illustrates a view showing one example of operation performed on the electronic apparatus.

FIG. 10 illustrates a view showing one example of operation performed on the electronic apparatus.

FIG. 11 illustrates a view showing one example of operation performed on the electronic apparatus.

FIG. 12 illustrates a view showing one example of operation performed on the electronic apparatus.

FIG. 13 illustrates a flowchart showing one example of operation of the electronic apparatus.

FIG. 14 illustrates a view showing one example of operation performed on the electronic apparatus.

FIG. 15 illustrates a view showing one example of operation performed on the electronic apparatus.

FIG. 16 illustrates a flowchart showing one example of operation of the electronic apparatus.

### DETAILED DESCRIPTION

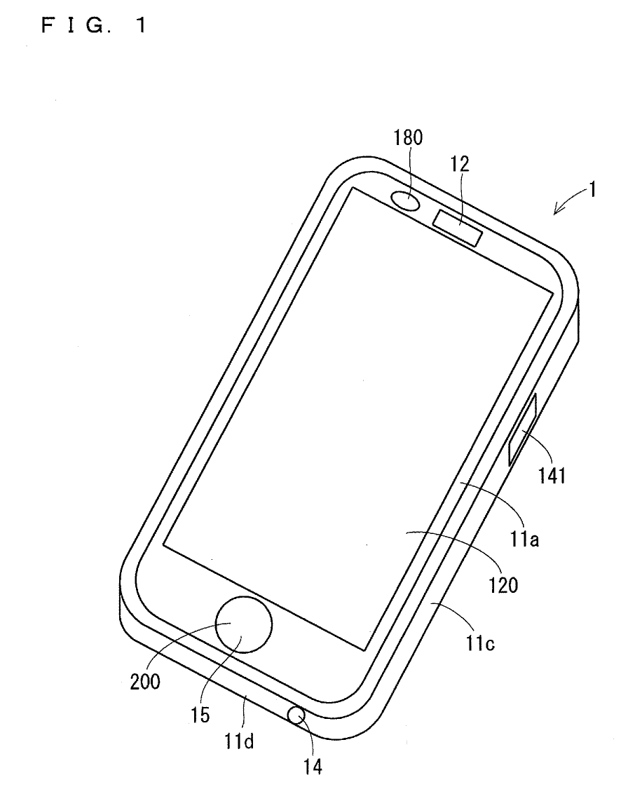

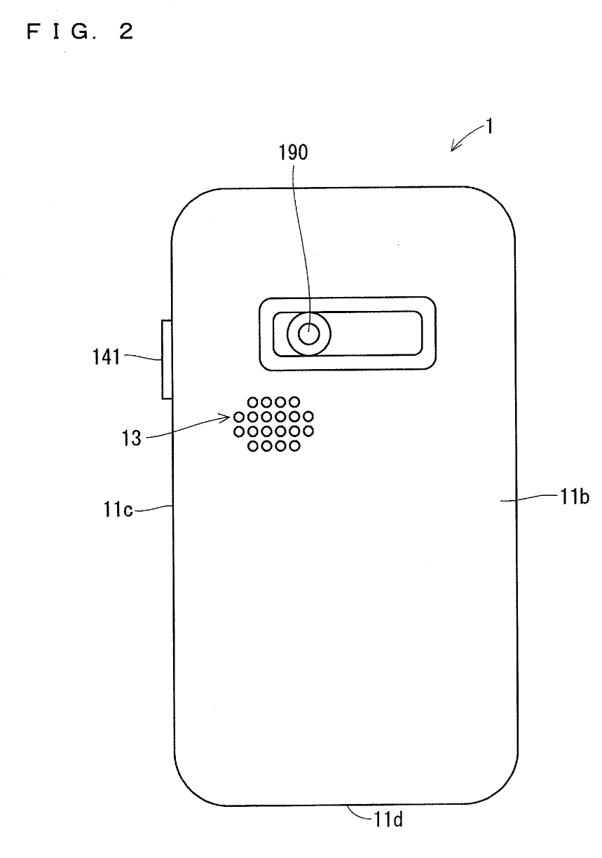

FIG. 1 and FIG. 2 illustrate a perspective view and a back view showing one example of external appearance of an electronic apparatus 1, respectively.

On a front surface 11a of the electronic apparatus 1, a display 120 that displays various pieces of information such as letters, symbols, and graphics is disposed. A touch sensor 130 is located on a back surface side of the display 120. A user can input various pieces of information into the electronic apparatus 1 by operating the display 120 on the front surface of the electronic apparatus 1 with a finger or the like. Note that, the user can input various pieces of information into the electronic apparatus 1 by operating the display 120 with a pointer other than a finger, that is, for example, a touch-panel pen such as a stylus pen.

A receiver hole 12 is located at an upper end portion of the front surface 11a of the electronic apparatus 1. A microphone hole 14 is located on a side surface 11d on a lower side of the electronic apparatus 1. A lens of a first camera 180 is visually recognizable from an upper end portion of the front surface 11a of the electronic apparatus 1. As illustrated in FIG. 2, a lens of a second camera 190 is visually recognizable from a back surface 11b of the electronic apparatus 1, i.e., from an upper end portion of the back surface of the electronic apparatus 1. Further, a speaker hole 13 is located in the back surface 11b of the electronic apparatus 1.

A detecting surface 15 is located at a lower end portion of the front surface 11a of the electronic apparatus 1. With the aid of a fingerprint sensor 200, the electronic apparatus 1 can detect operation performed on the detecting surface 15. It can also be said that the detecting surface 15 is a detecting region. Note that, the location of the detecting surface 15 is not limited to one example of FIG. 1, and the detecting surface 15 may be located on the display 120, for example.

The electronic apparatus 1 comprises an operation button group 140 that consists of a plurality of operation buttons. Each operation button is a hardware button, for example, and is located on a surface of the electronic apparatus 1. Each operation button is a push button, for example. The operation button group 140 comprises a power button 141. The power button 141 is located on a side surface 11c of the electronic apparatus 1.

The operation button group 140 comprises operation buttons other than the power button 141. For example, the operation button group 140 comprises a volume button.

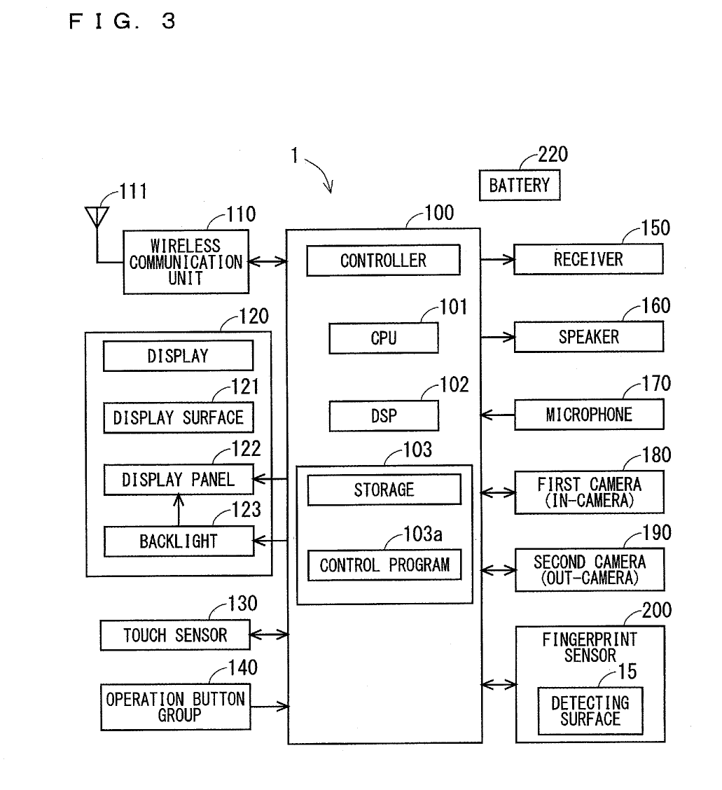

FIG. 3 illustrates a block diagram mainly showing one example of electrical configuration of the electronic apparatus 1. As illustrated in FIG. 3, the electronic apparatus 1 comprises a controller 100, a wireless communication unit 110, a display 120, a touch sensor 130, and an operation button group 140. Further, the electronic apparatus 1 comprises a receiver 150, a speaker 160, a microphone 170, a first camera 180, a second camera 190, a fingerprint sensor 200, and a battery 220.

The controller 100 can integrally manage operation of the electronic apparatus 1 by controlling other components of the electronic apparatus 1. It can also be said that the controller 100 is a control device or a control circuit. The controller 100 comprises at least one processor for providing control and processing capability to perform various functions as described in further detail below.

In accordance with various embodiments, the at least one processor may be implemented as a single integrated circuit (IC) or as multiple communicatively coupled IC's and/or discrete circuits. It is appreciated that the at least one processor can be implemented in accordance with various known technologies.

In one embodiment, the processor comprises one or more circuits or units configurable to perform one or more data computing procedures or processes by executing instructions stored in an associated memory, for example. In other embodiments, the processor may be implemented as firmware (e.g. discrete logic components) configured to perform one or more data computing procedures or processes.

In accordance with various embodiments, the processor may comprise one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In one embodiment, the controller 100 comprises a central processing unit (CPU) 101, a digital signal processor (DSP) 102, and a storage 103. The storage 103 comprises a non-transitory recording medium that can be read by the CPU 101 and the DSP 102, such as a read only memory (ROM) and a random access memory (RAM). The ROM of the storage 103 is, for example, a flash ROM (flash memory) being a non-volatile memory. The storage 103 stores a plurality of control programs 103a for controlling the electronic apparatus 1, etc. Various functions of the controller 100 are implemented by the CPU 101 and the DSP 102 executing the various control programs 103a in the storage 103.

Note that, the controller 100 may comprise a plurality of CPUs 101. In this case, the controller 100 may comprise a main CPU of high processing capability that performs comparatively complicated processing, and a sub-CPU of low processing capability that performs comparatively simple processing. Further, the controller 100 may omit the DSP 102, or may comprise a plurality of DSPs 102. Further, all of the functions of the controller 100 or some of the functions of the controller 100 may be implemented by a hardware circuit that does not require software to implement the functions.

The storage 103 may comprise a non-transitory recording medium that can be read by a computer, other than the ROM and the RAM. The storage 103 may comprise, for example, a small-sized hard disk drive and a solid state drive (SSD)

The plurality of control programs 103a in the storage 103 comprise various applications (i.e., application programs). The storage 103 stores, for example, a phone application for making a voice call and a video call, and an email application for creating, viewing, sending, and receiving electronic email. The storage 103 stores a camera application for capturing an image of an object using the first camera 180 and the second camera 190, an image application for displaying still images stored in the storage 103, etc. The storage 103 stores fingerprint information that is registered in advance in the electronic apparatus 1 by the user. At least one application in the storage 103 may be an application stored in the storage 103 in advance. Further, at least one application in the storage 103 may be an application downloaded from another device by the electronic apparatus 1 to be stored in the storage 103.

The wireless communication unit 110 comprises an antenna 111. The wireless communication unit 110 can, for example, wirelessly communicate in a plurality of types of communication modes using the antenna 111. The wireless communication of the wireless communication unit 110 is controlled by the controller 100.

The wireless communication unit 110 can wirelessly communicate with a base station of a mobile phone system. The wireless communication unit 110 can communicate with a mobile phone device that is different from the electronic apparatus 1, a web server, etc. via a network such as a base station and an internet. The electronic apparatus 1 can perform data communication, voice calls, video calls, etc. with another mobile phone device or the like.

Further, wireless communication can be performed using the wireless communication unit 110 and a wireless local area network (LAN) such as WiFi. Further, the wireless communication unit 110 can perform short-range wireless communication. For example, the wireless communication unit 110 can wirelessly communicate in conformity to Bluetooth (trademark). The wireless communication unit 110 may be able to wirelessly communicate in conformity to at least one of ZigBee (trademark) and near field communication (NFC).

The wireless communication unit 110 subjects an incoming signal received at the antenna 111 to various types of processing such as amplification processing, and then outputs the processed signal to the controller 100. The controller 100 subjects an incoming signal to various types of processing to acquire information contained in the incoming signal. Further, the controller 100 outputs a signal containing information to the wireless communication unit 110. The wireless communication unit 110 subjects an incoming signal to various types of processing such as amplification processing, and then wirelessly transmits the processed signal from the antenna 111.

The display 120 comprises a display surface 121 located in the front surface 11a of the electronic apparatus 1, a display panel 122, and a backlight 123. The display 120 can display various pieces of information in the display surface 121. The display panel 122 is, for example, a liquid crystal display panel, and comprises a plurality of pixels (also referred to as a “pixel unit” or a “pixel circuit”). The display panel 122 comprises, for example, liquid crystals, a glass substrate, a polarizing plate, etc. The display panel 122 is opposed to the display surface 121 in the electronic apparatus 1. Information displayed in the display 120 is displayed in the display surface 121 on a surface of the electronic apparatus 1. The backlight 123 irradiates the display panel 122 with light from the back of the display panel 122. The backlight 123 comprises, for example, at least one light emitting diode (LED). With the control of the controller 100, the display panel 122 can control, per each pixel, a transmission amount of light emitted from the backlight 123. The display panel 122 can display various pieces of information. With the control of the controller 100 that is performed on each pixel of the display panel 122 during lighting of the backlight 123, the display 120 can display various pieces of information such as letters, symbols, and graphics. The controller 100 can control the backlight 123. The controller 100 can, for example, turn on and off the backlight 123.

Note that, the display panel 122 may be a display panel other than a liquid crystal display panel. For example, the display panel 122 may be a light-emitting display panel such as an organic electroluminescence (EL) panel. In this case, the backlight 123 is not necessary.

The touch sensor 130 can detect operation performed on the display 120 by a pointer such as a finger. It can also be said that the touch sensor 130 is a sensor that detects operation performed on the display 120. The touch sensor 130 is, for example, a projected capacitive touch sensor. The touch sensor 130 is, for example, located on the back of the display 120. When the user performs operation on the display 120 with a pointer such as a finger, the touch sensor 130 can input an electrical signal corresponding to the operation into the controller 100. The controller 100 can specify the detail of the operation performed on the display 120 based on the electrical signal (output signal) from the touch sensor 130. Then, the controller 100 can perform processing depending on the specified detail of the operation. Note that, in place of the display panel 122 and the touch sensor 130, an in-cell display panel with a built-in touch sensor may be adopted.

When operated by the user, each operation button of the operation button group 140 can output to the controller 100 an operation signal indicating that the button has been operated. The controller 100 can determine, concerning each operation button, whether or not the operation button has been operated. When the controller 100 that has received the operation signal controls other components, a function allocated to the operated operation button is implemented in the electronic apparatus 1.

The microphone 170 can convert sound input from the outside of the electronic apparatus 1 into an electrical sound signal, and can output the converted signal to the controller 100. Sound from the outside of the electronic apparatus 1 is taken into the electronic apparatus 1 through the microphone hole 14, and is then input to the microphone 170.

The speaker 160 is, for example, a dynamic speaker. The speaker 160 can convert an electrical sound signal from the controller 100 into sound, and can output the converted sound. The sound output from the speaker 160 is output to the outside through the speaker hole 13. The user can hear the sound output from the speaker hole 13 even at a place away from the electronic apparatus 1.

The receiver 150 can output received voice sound. The receiver 150 is, for example, a dynamic speaker. The receiver 150 can convert an electrical sound signal from the controller 100 into sound, and can output the converted sound. The sound output from the receiver 150 is output to the outside through the receiver hole 12. The volume of the sound output through the receiver hole 12 is smaller than the volume of the sound output through the speaker hole 13. The user brings his/her ear closer to the receiver hole 12 to hear the sound output through the receiver hole 12. Note that, in place of the receiver 150, a vibration element such as a piezoelectric vibration element that vibrates a front surface portion of the electronic apparatus 1 may be provided. In this case, sound is conveyed to the user through the vibration of the front surface portion.

The first camera 180 comprises a lens, an image sensor, etc. The second camera 190 comprises a lens, an image sensor, etc. Each of the first camera 180 and the second camera 190 can capture an image of an object in accordance with the control of the controller 100, can produce a still image or a moving image depicting the captured object, and can output the image to the controller 100.

The lens of the first camera 180 is visually recognizable from the front surface 11a of the electronic apparatus 1. Therefore, the first camera 180 can capture an image of an object present at the front surface side (i.e., the display 120 side) of the electronic apparatus 1. The first camera 180 is referred to as an in-camera. Meanwhile, the lens of the second camera 190 is visually recognizable from the back surface 11b of the electronic apparatus 1. Therefore, the second camera 190 can capture an image of an object present at the back surface side of the electronic apparatus 1. The second camera 190 is referred to as an out-camera.

The fingerprint sensor 200 can scan fingerprint information of a finger brought into contact with the detecting surface 15. Further, the fingerprint sensor 200 can detect operation performed on the detecting surface 15 by a pointer such as a finger. For example, the fingerprint sensor 200 can detect slide operation and flick operation performed on the detecting surface 15 by a pointer. The slide operation is operation in which a pointer such as a finger moves on an operated surface with the pointer remaining in contact with the operated surface. The operated surface is a surface that detects operation performed by a finger or the like. The operated surface may comprise the detecting surface 15. The operated surface may comprise the display 120. The flick operation is operation in which the operated surface is flicked by a pointer such as a finger. Operation performed on the operated surface by a pointer may be hereinafter referred to as “moving operation.”

For example, the fingerprint sensor 200 may be able to detect moving operation performed on the detecting surface 15 in the right and left direction and the up and down direction. The detecting surface 15 is a part where a finger 500 directly comes in contact. The detecting surface 15 is a surface where the finger 500 of the user comes in contact such that the fingerprint sensor 200 scans fingerprint information, and is a region capable of fingerprint detection. There is no limitation as to the location of the fingerprint sensor 200. For example, the fingerprint sensor 200 may be located on a lower side of the detecting surface 15. Further, as illustrated in FIG. 3, a part of the fingerprint sensor 200 may serve as the detecting surface 15.

The method of detecting a fingerprint with the fingerprint sensor 200 is, for example, an electrostatic capacitance method. The electrostatic capacitance between the fingerprint sensor 200 and a finger varies depending on the ridges and valleys formed in a fingerprint of the finger. Therefore, the fingerprint sensor 200 can scan fingerprint information of the finger by detecting electrostatic capacitance between the fingerprint sensor 200 and the finger. Further, if the method of detecting a fingerprint with the fingerprint sensor 200 is the electrostatic capacitance method, the fingerprint sensor 200 can detect moving operation performed on the detecting surface 15 similarly to the capacitive touch sensor 130.

Note that, the fingerprint sensor 200 may consist of two different sensors, that is, a sensor that scans fingerprint information of a finger brought into contact with the detect surface 15 and a sensor that detects moving operation performed on the detect surface 15. Further, the method of detecting a fingerprint with the fingerprint sensor 200 may be, for example, a method other than the electrostatic capacitance method. For example, the method of detecting a fingerprint with the fingerprint sensor 200 may be an optical method.

The battery 220 can output power of the electronic apparatus 1. The battery 220 is, for example, a rechargeable battery. The power output from the battery 220 is supplied to various components of the electronic apparatus 1, such as the controller 100 and the wireless communication unit 110.

Note that, the electronic apparatus 1 may comprise a sensor other than the touch sensor 130 and the fingerprint sensor 200. For example, the electronic apparatus 1 may comprise at least one of an accelerometer, an air-pressure sensor, a geomagnetic sensor, a temperature sensor, a proximity sensor, an illuminance sensor, and a gyro sensor.

The electronic apparatus 1 comprises a number of operation modes. Examples of the operation modes of the electronic apparatus 1 include a normal mode, a sleep mode, and a shutdown mode. During the shutdown mode, the electronic apparatus 1 is shut down, and most of the functions of the electronic apparatus 1 are stopped. During the sleep mode, some of the functions of the electronic apparatus 1, including a display function, are stopped. The normal mode refers to a state in which the electronic apparatus 1 operates in a mode other than the sleep mode and the shutdown mode. The controller 100 controls predetermined components of the electronic apparatus 1 in accordance with an operation mode to be set, thereby setting the operation mode of the electronic apparatus 1.

During the sleep mode, for example, some components of the electronic apparatus 1, including the display panel 122, the backlight 123, the touch sensor 130, the first camera 180, the second camera 190, etc., do not operate. During the shutdown mode, most of the components of the electronic apparatus 1, including the display panel 122, the backlight 123, the touch sensor 130, the first camera 180, the second camera 190, etc., do not operate. Power consumption of the electronic apparatus 1 is further reduced in the sleep mode than that in the normal mode. Power consumption of the electronic apparatus 1 is further reduced in the shutdown mode than that in the sleep mode.

Further, the display 120 enters a non-display state during the sleep mode and the shutdown mode. A display state refers to a state in which the electronic apparatus 1 intentionally implements display in the display 120. Further, the non-display state refers to a state in which the electronic apparatus 1 intentionally does not implement display in the display 120. In one embodiment, when the backlight 123 is turned off, the electronic apparatus 1 cannot intentionally implement display in the display 120. Therefore, the display 120 enters the non-display state when the backlight 123 is turned off. In other words, the display 120 enters the non-display state when the backlight 123 is not driven. Further, in a case where the display panel 122 is a light-emitting display panel such as an organic EL panel, the display 120 enters the non-display state when all of the pixels do not emit light. That is, the display 120 enters the non-display state when the entire region of the display region in the display panel 122 is turned off.

When the power button 141 is pressed for a long period of time during the normal mode, the display 120 shows a confirmation screen for confirming with the user whether or not the mode is to be transitioned from the normal mode to the shutdown mode. When the user performs predetermined operation on the display 120 while the display 120 displays the confirmation screen, the mode is transitioned from the normal mode to the shutdown mode.

Further, when no operation is performed on the electronic apparatus 1 for a certain period of time or more during the normal mode, the mode is transitioned from the normal mode to the sleep mode. Further, when the power button 141 is pressed for a short period of time during the normal mode, the mode is transitioned from the normal mode to the sleep mode.

On the other hand, when the power button 141 is pressed for a short period of time during the sleep mode, the mode is transitioned from the sleep mode to the normal mode. That is, when the power button 141 is pressed for a short period of time during the sleep mode, functions once stopped in transitioning into the sleep mode are restored in the electronic apparatus 1. In one embodiment, the normal mode comprises a lock mode. When the power button 141 is pressed for a short period of time during the sleep mode, the mode is transitioned from the sleep mode to the lock mode. Further, when predetermined operation is performed on the detecting surface 15 during the sleep mode, the mode is transitioned from the sleep mode to the normal mode.

Note that, even if particular description is not given, the normal mode comprises operation modes of the electronic apparatus 1 described below except for the shutdown mode and the sleep mode. Further, the term “operation mode” itself refers to the operation mode of the electronic apparatus 1. Further, operation in which a surface of the electronic apparatus 1 is pressed for a short period of time without changing the pressing position, i.e., operation in which a surface of the electronic apparatus 1 is pressed for less than a first predetermined period of time without changing the pressing position, is referred to as “short-pressing operation.” Further, operation in which a surface of the electronic apparatus 1 is pressed for a long period of time without changing the pressing position, i.e., operation in which a surface of the electronic apparatus 1 is pressed for a second predetermined period of time (≥first predetermined period of time) or more without changing the pressing position, may be referred to as “long-pressing operation.”

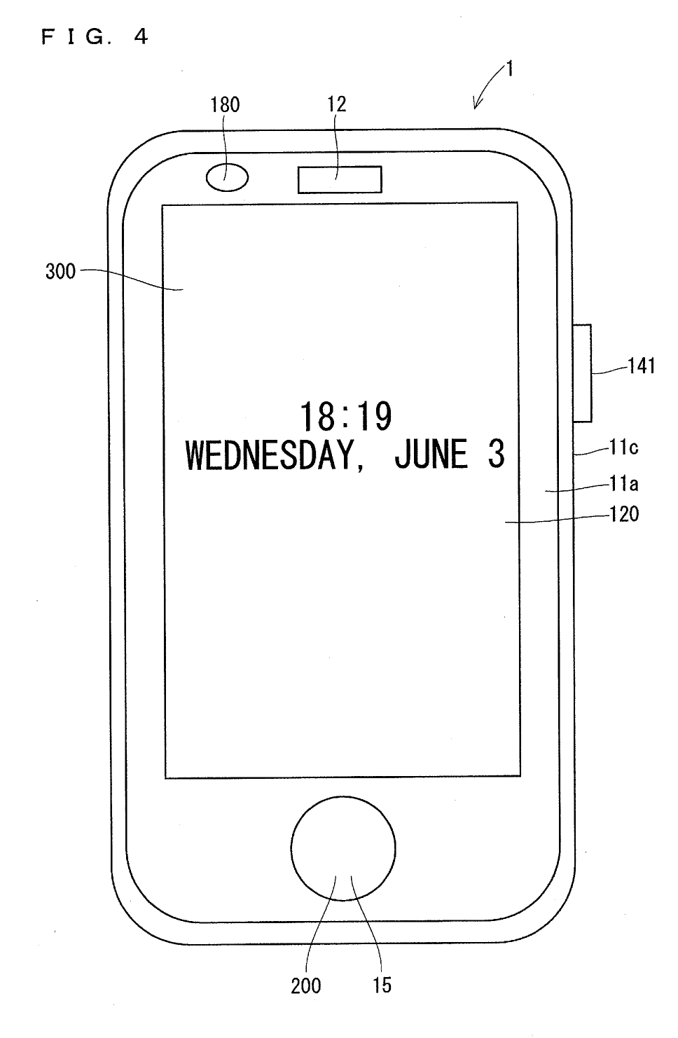

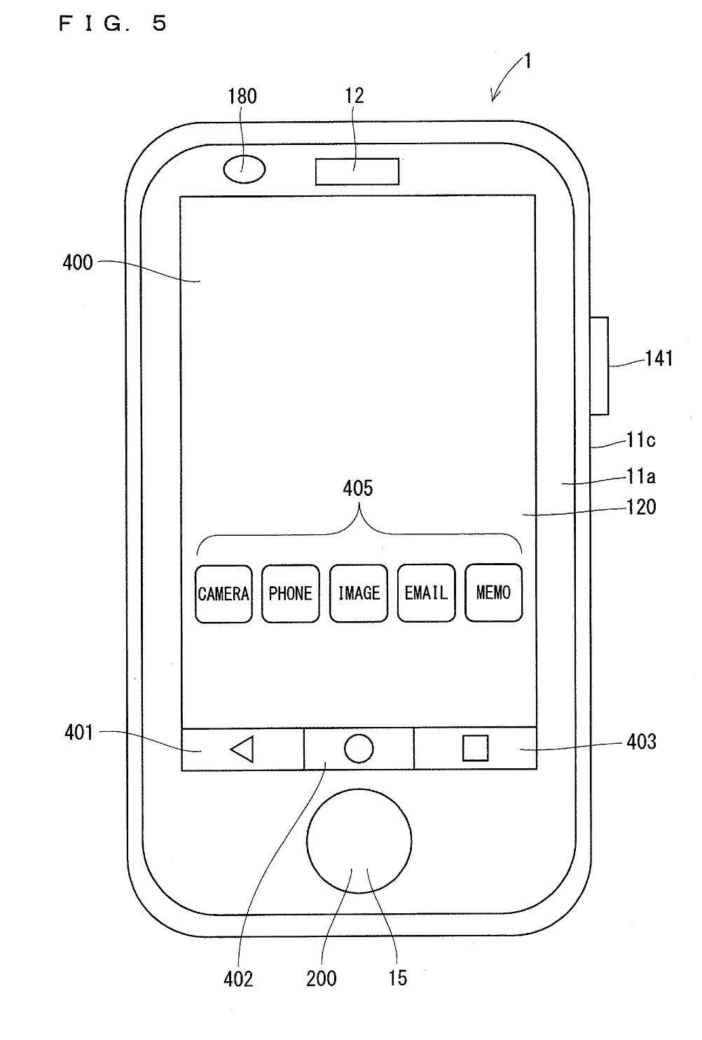

The display 120 displays various screens during the normal mode. It can also be said that a screen displayed in the display 120 is an image displayed in the display 120. The display 120 displays, for example, a home screen 400 and a lock screen 300. FIG. 4 illustrates a view showing one example of the lock screen 300. FIG. 5 illustrates a view showing one example of the home screen 400.

As illustrated in FIG. 4, the lock screen 300 shows, for example, the current time, the current date, and the current day.

The normal mode comprises the lock mode, where the user cannot make the electronic apparatus 1 execute applications other than certain applications (such as a calling application and a camera application) among the plurality of applications in the storage 103. The lock mode is also referred to as a screen lock mode. During the lock mode, the user cannot instruct the electronic apparatus 1 to execute each application other than the certain applications among the plurality of applications in the storage 103. The lock screen 300 is a screen to notify that the electronic apparatus 1 is in a lock mode, and is displayed in the display 120 when the operation mode is the lock mode. Note that, the lock mode is a mode in which the user cannot execute some or all of the applications in the storage 103.

When the power button 141 is pressed for a short period of time during the sleep mode, the sleep mode is disabled and the operation mode is brought into the lock mode. In the lock mode, the controller 100 displays the lock screen 300 in the display 120. When the user performs predetermined operation on the electronic apparatus 1 while the display 120 displays the lock screen 300, the lock mode is disabled in the electronic apparatus 1, and display in the display 120 is transitioned from the lock screen 300 into another screen such as the home screen 400 (see FIG. 5). A state in which the lock mode is disabled during the normal mode may be hereinafter referred to as an “unlocked mode.”

The home screen 400 shows, as illustrated in FIG. 5, a plurality of operation buttons 401 to 403. Each of the operation buttons 401 to 403 is a software button. The operation buttons 401 to 403 are also shown in a screen other than the home screen 400 during the unlocked mode.

The operation button 401 is, for example, a back button. The back button is an operation button for switching display of the display 120 into a previous display. When the user performs predetermined operation on the operation button 401, display of the display 120 is switched into a previous display. For example, when the user performs tap operation on the operation button 401, display of the display 120 is switched into a previous display. The tap operation is operation in which a finger comes in contact with the operated surface and then immediately moves away from the contact position. The operation button 402 is, for example, a home button. The home button is an operation button for displaying the home screen 400 in the display 120. When the user performs tap operation on the operation button 402, for example, the home screen 400 is displayed in the display 120. The operation button 403 is, for example, a history button. The history button is an operation button for displaying, in the display 120, the history of applications executed in the electronic apparatus 1. When the user performs tap operation on the operation button 403, for example, the history of applications executed in the electronic apparatus 1 is displayed in the display 120.

Further, the home screen 400 shows icons 405 for instructing the electronic apparatus 1 to execute corresponding applications in accordance with applications in the storage 103. In one example of FIG. 5, the home screen 400 shows five icons 405. The icons represent applications of camera, phone, image, email, and memo. The user can select the icon 405 by performing predetermined operation (such as tap operation) on the icon 405. The controller 100 reads out an application corresponding to the selected icon 405 from the storage 103 to execute the application. That is, when the touch sensor 130 detects predetermined operation performed on the icon 405, the controller 100 reads out an application corresponding to the icon 405 from the storage 103 to execute the application. It can also be said that execution of an application corresponding to the icon 405 is implementation of the function of the icon 405. The user can select the icon 405 by performing operation on the icon 405, and can thus make the electronic apparatus 1 execute an application corresponding to the selected icon 405. For example, when the user performs tap operation on the icon 405 that corresponds to a browser, a browser is executed in the electronic apparatus 1. Further, when the user performs tap operation on the icon 405 that corresponds to a camera application, a camera application is executed in the electronic apparatus 1.

The home screen 400 is made up of a plurality of pages. In FIG. 5, one page of the home screen 400 is illustrated. Each page shows the operation buttons 401 to 403 and the icons 405. The plurality of pages of the home screen 400 are arrayed virtually in the right and left direction. When the user performs flick operation or slide operation on the display 120 in the right and left direction, an adjacent page is shown in the display 120.

When the operation mode is the normal mode, the controller 100 can perform fingerprint authentication based on fingerprint information scanned by the fingerprint sensor 200. Given below is the description of one example of the fingerprint authentication.

In performing fingerprint authentication, the controller 100 produces a fingerprint image that represents fingerprint information scanned by the fingerprint sensor 200 based on an output signal from the fingerprint sensor 200. Then, the controller 100 extracts feature points representing features of the scanned fingerprint information from the produced fingerprint image. The positions of an ending point and a bifurcation point of a ridge (raised portion), the thickness of a ridge, etc. of the fingerprint are used as the feature points, for example. Then, the controller 100 compares the extracted feature points and reference feature points stored in the storage 103. The reference feature points are feature points extracted from a fingerprint image representing fingerprint information of an authorized user (such as the owner of the electronic apparatus 1). As a result of the comparison between the extracted feature points and the reference feature points, the controller 100 determines that the fingerprint authentication has succeeded if both of the feature points are similar to each other. The fingerprint authentication may be regarded as one type of user authentication. Therefore, it can be said that, if the extracted feature points and the reference feature points are similar to each other, the controller 100 determines that the user who has the fingerprint information scanned by the fingerprint sensor 200 is the authorized user. On the other hand, if the extracted feature points and the reference feature points are not similar to each other, the controller 100 determines that the fingerprint authentication has failed. That is, the controller 100 determines that the user who has the fingerprint information scanned by the fingerprint sensor 200 is an unauthorized user.

The normal mode comprises a fingerprint registration mode for registering fingerprint information of the user in the electronic apparatus 1. The electronic apparatus 1 operates in the fingerprint registration mode when predetermined operation is performed on the display 120 during the unlocked mode. When the authorized user places a finger (the pad of the finger, to be specific) of his/her hand on the detecting surface 15 during the fingerprint registration mode, the fingerprint sensor 200 scans fingerprint information of the finger. The controller 100 produces a fingerprint image that represents fingerprint information scanned by the fingerprint sensor 200 based on an output signal from the fingerprint sensor 200. Then, the controller 100 extracts feature points from the produced fingerprint image, and stores the extracted feature points in the storage 103 as reference feature points. The reference feature points representing the features of the fingerprint of the authorized user are stored in the storage 103. That is, the fingerprint information of the authorized user is registered in the electronic apparatus 1. Fingerprint information that is registered in advance in the electronic apparatus 1 as described above is referred to as registered fingerprint information.

Note that, the storage 103 in some cases stores a plurality of sets of reference feature points. In such cases, the controller 100 compares the extracted feature points with each of the plurality of sets of reference feature points stored in the storage 103. The controller 100 determines that the fingerprint authentication has succeeded if the plurality of sets of reference feature points contain a set of reference feature points that is similar to the extracted feature points. On the other hand, the controller 100 determines that the fingerprint authentication has failed if the plurality of sets of reference feature points do not contain a set of reference feature points that is similar to the extracted feature points.

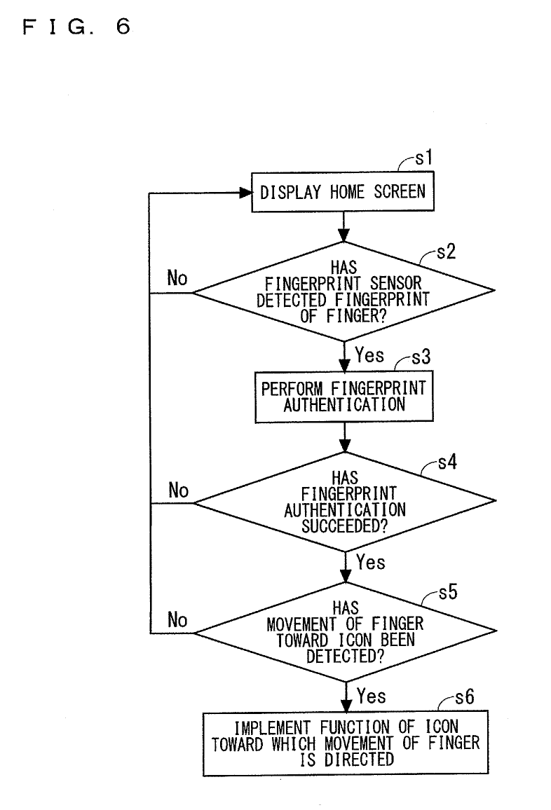

In one embodiment, if movement of the finger 500 toward an icon 405 is detected by at least one of the fingerprint sensor 200 and the touch sensor 130 based on the scanned fingerprint information and the registered fingerprint information that is registered in advance, the electronic apparatus 1 implements the function of the icon 405. FIG. 6 illustrates a flowchart showing one example of operation of the electronic apparatus 1 when the electronic apparatus 1 implements the function of the icon 405.

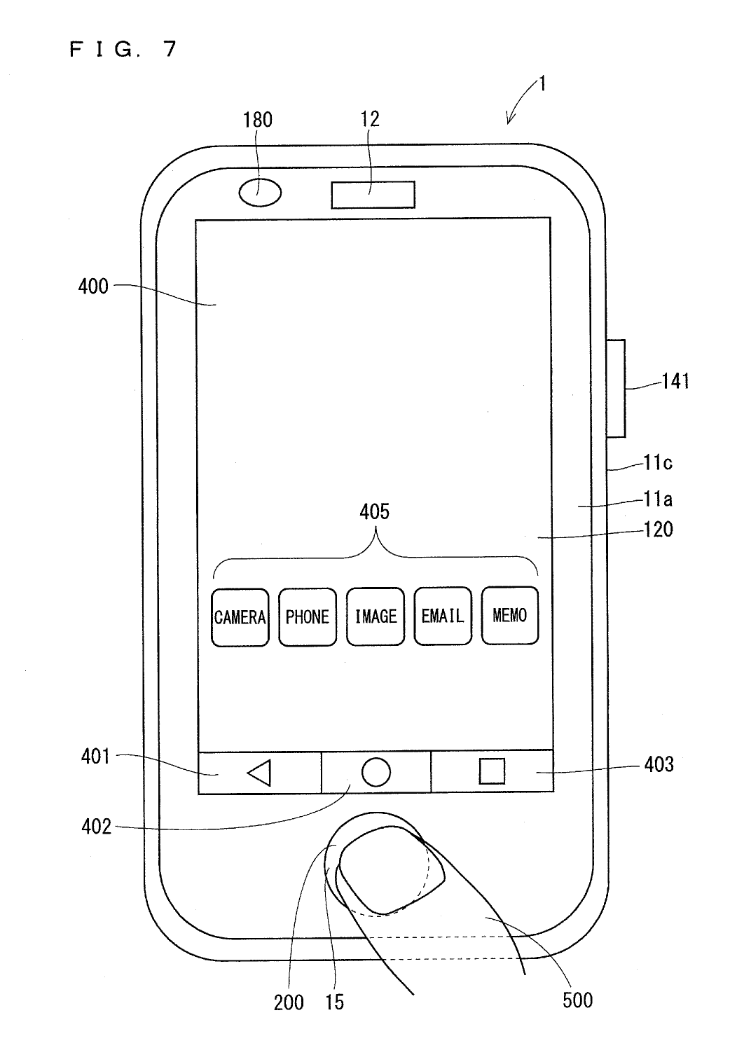

In Step s1, the controller 100 displays the home screen 400 in the display 120. In Step s2, if the fingerprint sensor detects a fingerprint of the finger 500 based on an output signal of the fingerprint sensor 200, the process in the controller 100 proceeds to Step s3. FIG. 7 illustrates a view in which the finger 500 is in contact with the detecting surface 15 when the home screen 400 is displayed.

In Step s3, the controller 100 performs fingerprint authentication based on the fingerprint information scanned by the fingerprint sensor 200. After Step s3, the controller 100 determines whether or not the fingerprint authentication has succeeded in Step s4. If determination is made that the fingerprint authentication has succeeded, the process proceeds to Step s5.

If the fingerprint authentication has failed, the controller 100 may display in the home screen 400 information notifying that the fingerprint authentication has failed. The user can easily know that the fingerprint authentication has failed because information notifying that the fingerprint authentication has failed is displayed in the case where fingerprint authentication has failed.

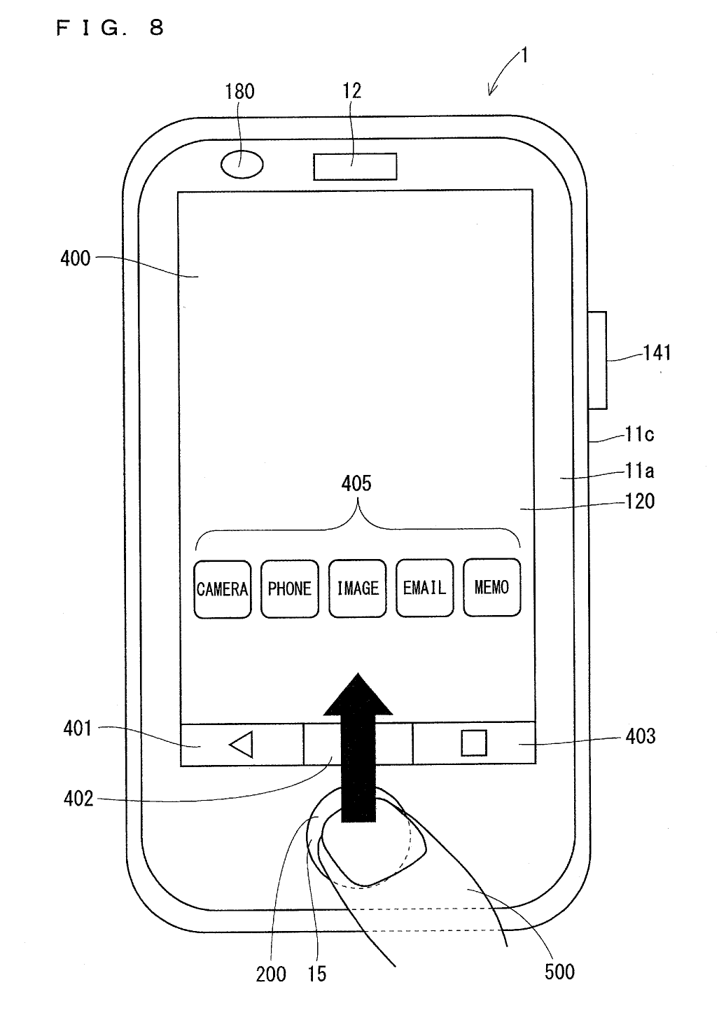

In Step s5, the controller 100 detects whether or not the finger 500 has moved toward an icon 405. FIG. 8 illustrates a view in which the finger 500, after coming into contact with the detecting surface 15, is continuously moved toward an icon 405 with the finger 500.

If determination is made in Step s5 that movement of the finger 500 toward an icon 405 has not been detected, the controller 100 does not implement the function of the icon 405 in Step s6.

In this manner, in one embodiment, if movement of the finger 500 toward an icon 405 has not been detected, the function of the icon 405 is not implemented. Therefore, the display 120 remains displaying the home screen 400.

The movement of the finger 500 may be detected by at least one of the fingerprint sensor 200 and the touch sensor 130. That is, the fingerprint sensor 200 may detect a moving direction of the finger 500 after the fingerprint sensor 200 scans fingerprint information. The fingerprint sensor 200 and the touch sensor 130 may detect movement of the finger 500 after the fingerprint sensor 200 scans fingerprint information. The touch sensor 130 may detect movement of the finger 500 after the fingerprint sensor 200 scans fingerprint information. If the fingerprint sensor 200 and the touch sensor 130 detect movement of the finger 500, a part where the movement of the finger 500 is not detected (such as the front surface 11a of the electronic apparatus 1) may be present between the fingerprint sensor 200 and the touch sensor 130.

The movement of the finger 500 comprises flick, slide, swipe, and drag. The swipe is operation in which the operated surface is swiped by a pointer such as the finger 500. The drag is operation in which a selected item is moved on the operated surface by a pointer such as the finger 500.

In Step s6, the controller 100 implements the function of the icon 405 in accordance with the moving direction of the finger 500. That is, the controller 100 implements the function of the icon 405 toward which the movement of the finger 500 is directed. The authorized user can make the electronic apparatus 1 implement the function of the icon 405 through a series of operation in which the authorized user brings his/her own finger 500 into contact with the detecting surface 15 and moves the finger 500 toward the icon 405. As a result, operability of the electronic apparatus 1 is enhanced.

In FIG. 6, the controller 100 first determines whether fingerprint authentication has succeeded, and then determines whether movement of the finger 500 toward an icon 405 has been detected. However, either of the determinations may be made first. That is, the controller 100 may determine whether fingerprint authentication has succeeded after determining whether movement of the finger 500 toward an icon 405 has been detected, and may then implement the function of the icon 405 toward which the movement of the finger 500 is directed.

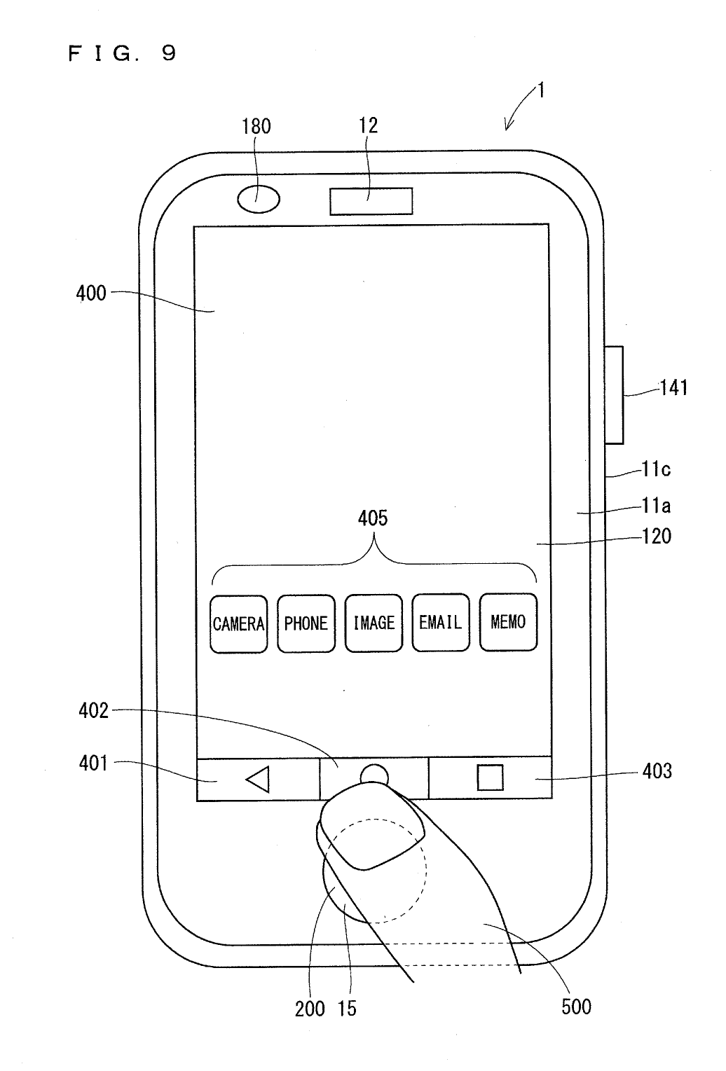

In one embodiment, the electronic apparatus 1 restricts operation of the touch sensor 130 while a finger is in contact with the detecting surface 15. FIG. 9 illustrates a view in which the finger 500 is in contact with the detecting surface 15 and the display 120. Being in contact with the detecting surface 15 refers to a state in which the contact of the finger 500 is being detected by the fingerprint sensor 200. In one example of FIG. 9, the display 120 is disposed near the fingerprint sensor 200. The controller 100 restricts operation on the display 120 while the detecting surface 15 is in contact. Restricting operation on the display 120 refers to a state in which, for example, even if the finger 500 comes into contact with an icon 405, the controller 100 does not implement the function of the icon 405. In one example of FIG. 9, although the finger 500 comes in contact with the detecting surface 15 and the operation button 402, the function of the operation button 402 is not implemented.

Erroneous operation can be prevented during fingerprint authentication even if the finger 500 unintentionally comes in contact with the display 120. As a result, operability of the electronic apparatus 1 is enhanced.

In one embodiment, based on the scanned fingerprint information, the electronic apparatus 1 changes the array order of the icons 405 to be displayed in the display 120.

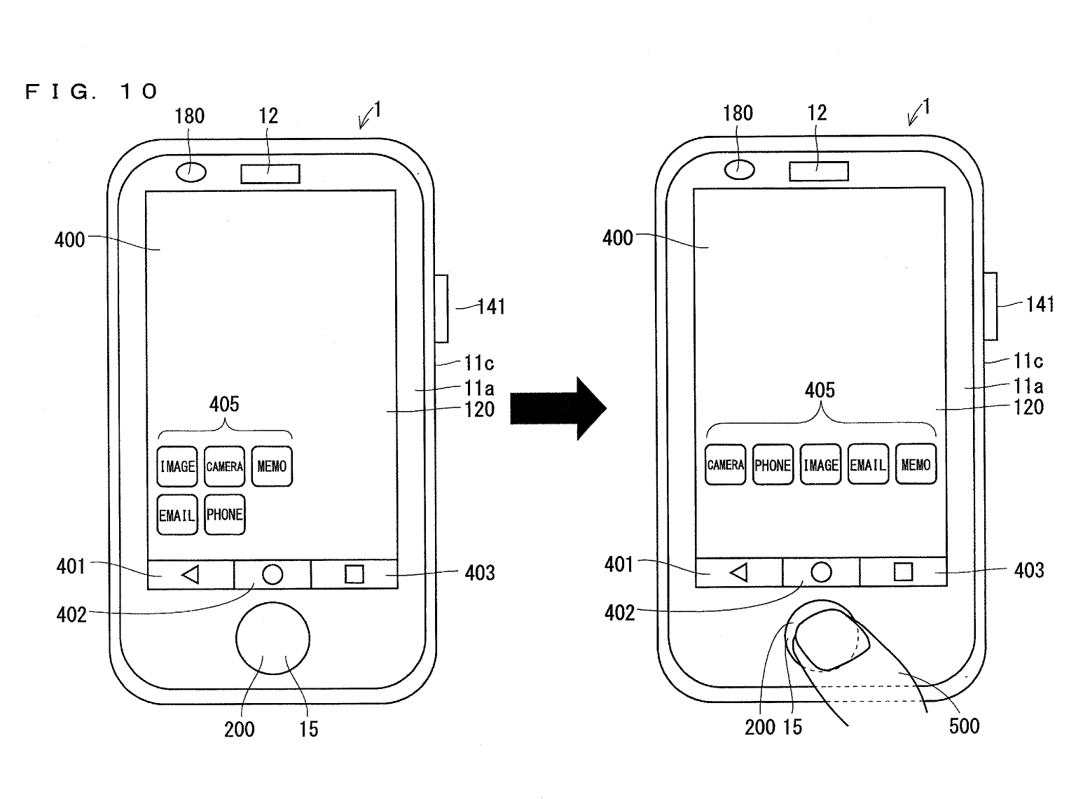

The left side of FIG. 10 illustrates the electronic apparatus 1 before the fingerprint sensor 200 scans fingerprint information. The right side of FIG. 10 illustrates the electronic apparatus 1 after the fingerprint sensor 200 scans fingerprint information, to change the array order of the icons 405 displayed on the display 120. In one example of FIG. 10, the array of the icons 405 in two horizontal rows is changed into one horizontal array after the fingerprint sensor 200 scans fingerprint information. If the user determines the array order of the icons 405, the user can specify, with respect to the electronic apparatus 1, the array order of the icons 405 to be displayed on the display 120 by operating the display 120, for example. If the electronic apparatus 1 determines the array order of the icons 405, the controller 100 sorts icons 405 that correspond to frequently executed applications in ascending order from the detecting surface 15, for example.

The array order of the icons 405 may differ depending on scanned fingerprint information. For example, the array order of the icons 405 may differ per fingerprint information of different fingers 500 of a single user. Alternatively, the array order of the icons 405 may differ per fingerprint information of fingers 500 of a plurality of different users.

The manner of changing the array order of the icons 405 may differ depending on scanned fingerprint information. For example, the manner of changing the array order of the icons 405 may differ per fingerprint information of different fingers 500 of a single user. Alternatively, the manner of changing the array order of the icons 405 may differ per fingerprint information of fingers 500 of a plurality of different users.

The icons 405 are sorted based on fingerprint information, which makes it easier to find the icon 405 whose function is desired to be implemented. As a result, operability of the electronic apparatus 1 is enhanced.

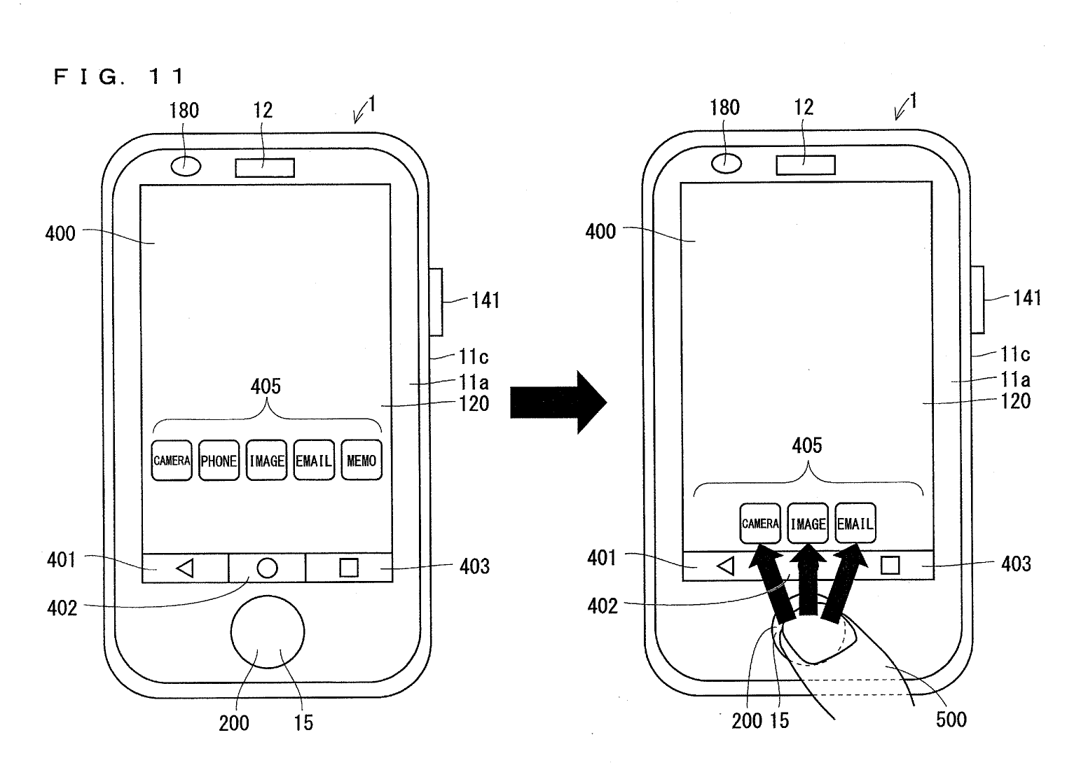

In one embodiment, the electronic apparatus 1 displays the icons 405 near the fingerprint sensor 200 based on the scanned fingerprint information. The left side of FIG. 11 illustrates the electronic apparatus 1 before the fingerprint sensor 200 scans fingerprint information. The right side of FIG. 11 illustrates the electronic apparatus 1 after the fingerprint sensor 200 scans fingerprint information, to display the icons 405 near the detecting surface 15. In one example of FIG. 11, three icons 405, among five icons 405 arrayed in one horizontal row, are arrayed near the detecting surface 15. The user may register the icons 405 to be displayed near the detecting surface 15 in advance. Alternatively, the icons 405 frequently used by the user may be displayed near the detecting surface 15.

The icons 405 to be displayed near the detecting surface 15 may differ depending on scanned fingerprint information. For example, the icons 405 to be displayed near the detecting surface 15 may differ per fingerprint information of different fingers 500 of a single user. The icons 405 to be displayed near the detecting surface 15 may differ per fingerprint information of fingers 500 of a plurality of different users.

If the user determines the number of the icons 405 to be displayed near the detecting surface 15, the user can specify, with respect to the electronic apparatus 1, the number of the icons 405 to be displayed near the detecting surface 15 by operating the display 120, for example. If the electronic apparatus 1 determines the array order of the icons 405, the controller 100 sorts icons 405 that correspond to top three most frequently executed applications near the detecting surface 15. The array order of the icons to be displayed near the detecting surface 15 may be displayed in an arc-like shape.

Erroneous selection of the icon 405 can be decreased when the user moves his/her finger 500 toward the icon 405 desired to be implemented. Further, a moving distance of the finger 500 can be reduced when the user moves his/her finger 500 to the icon 405. As a result, operability of the electronic apparatus 1 is enhanced.

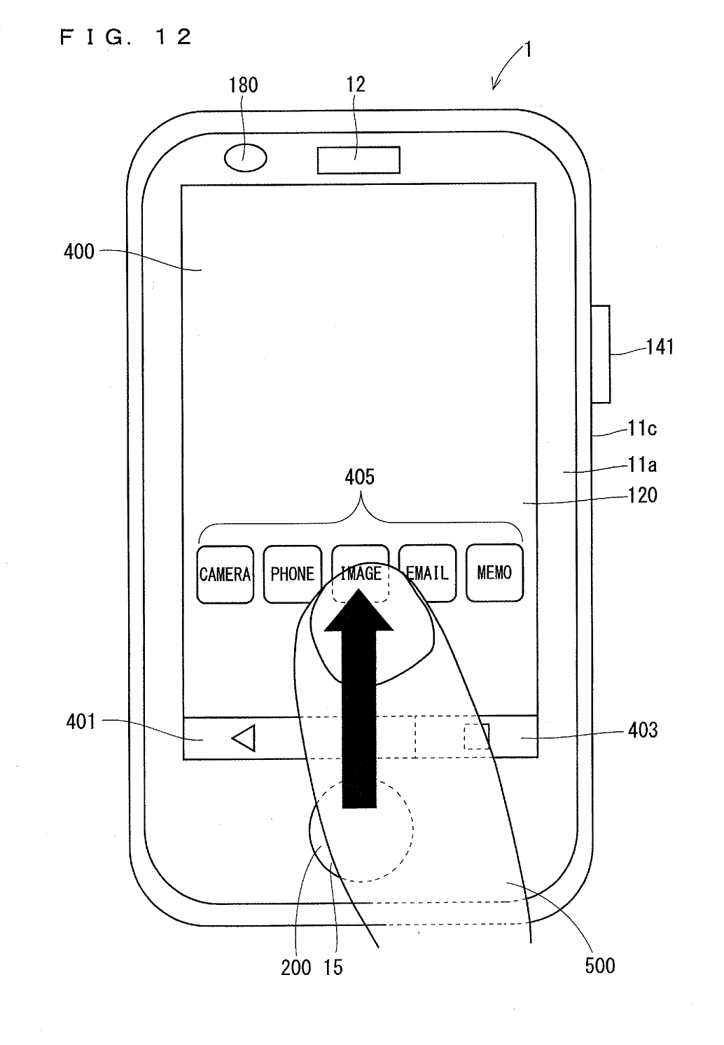

FIG. 12 illustrates a view showing operation in which, when movement of the finger 500 from the fingerprint sensor 200 toward an icon 405 is detected and then the contact of the finger 500 stops being detected on the icon 405, the electronic apparatus 1 implements the function of the icon 405. In one embodiment, in movement of the finger 500 from the fingerprint sensor 200 to an icon 405, the function of the icon 405 that has been in contact is implemented when the contact of the finger 500 stops being detected on the display 120 by the touch sensor 130.

Further, in one embodiment, when the finger 500 comes into contact with an icon 405 for a predetermined period of time, the electronic apparatus 1 implements the function of the icon 405. The predetermined period of time may be, for example, a period of time determined to be equal to or longer than the above-mentioned long-pressing operation.

If the user specifies the predetermined period of time, the user can specify, with respect to the electronic apparatus 1, a period of time in which the finger 500 is in contact with an icon 405 in order to implement the function of the icon 405 by operating the display 120, for example. If the electronic apparatus 1 makes the determination, for example, the controller 100 implements the function of an icon 405 after approximately 2 seconds of contact with the icon 405.

Erroneous selection of the icon 405 desired to be implemented can be decreased. As a result, operability of the electronic apparatus 1 is enhanced.

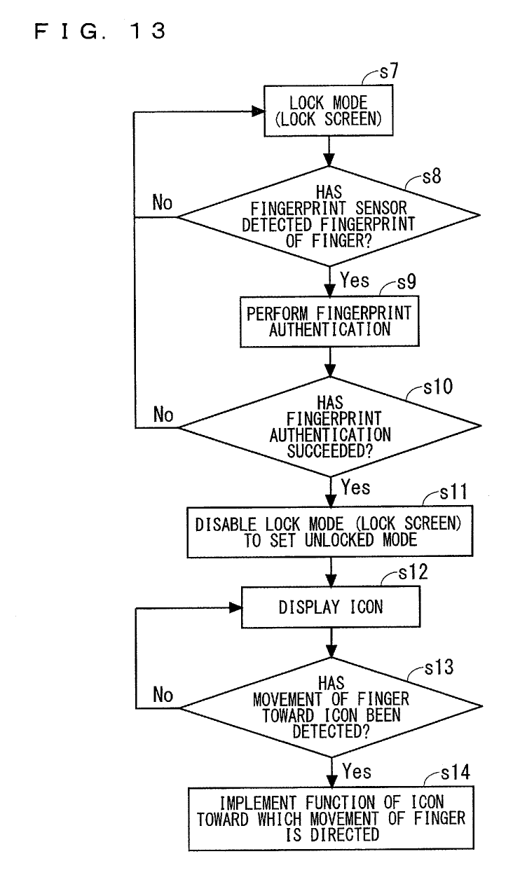

FIG. 13 illustrates a flowchart showing one example of operation of the electronic apparatus 1 when the electronic apparatus 1 implements the function of the icon 405 during a lock mode.

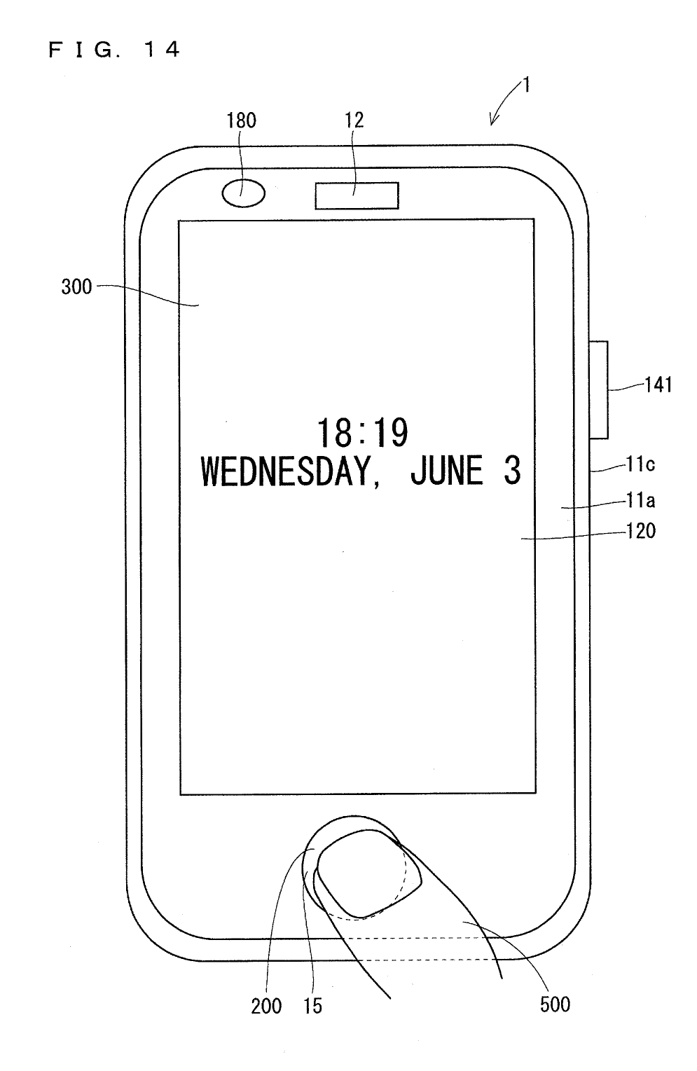

In one embodiment, during a lock mode, the electronic apparatus 1 disables the lock mode based on scanned fingerprint information and registered fingerprint information that is registered in advance. FIG. 13 illustrates a flowchart showing one example of an operating method of the electronic apparatus. Step s7 indicates that the electronic apparatus 1 is in a lock mode. In Step s8, if determination is made that the finger 500 is in contact with the detecting surface 15 based on an output signal of the fingerprint sensor 200, Step s9 is executed. FIG. 14 illustrates a view in which the finger 500 is in contact with the detecting surface 15 during a lock mode.

In Step s9, the controller 100 performs fingerprint authentication based on fingerprint information scanned by the fingerprint sensor 200. After Step s9, the controller 100 determines whether or not the fingerprint authentication has succeeded in Step s10.

If determination is made in Step s10 that the fingerprint authentication has succeeded, the controller 100 disables the lock mode to set the unlocked mode in Step s11. Then, in Step s12, as illustrated in FIG. 7, the controller 100 displays the icons 405 in the display 120.

If determination is made in Step s10 that the fingerprint authentication has failed, the controller 100 does not disable the lock mode in Step s11.

In this manner, in one embodiment, if the fingerprint authentication has failed, the function of the icon 405 toward which the movement of the finger 500 is directed is not implemented. Therefore, the display 120 remains displaying the lock screen 300.

Note that, if the fingerprint authentication has failed, information notifying that the fingerprint authentication has failed may be displayed in the home screen 400. The user can easily know that the fingerprint authentication has failed because information notifying that the fingerprint authentication has failed is displayed in the case where fingerprint authentication has failed.

In Step s13, after the icons 405 are displayed, whether or not the finger 500 has moved toward an icon 405 is detected (FIG. 8).

If determination is made in Step s13 that movement of the finger 500 toward an icon 405 has not been detected, the controller 100 does not implement the function of the icon 405 in Step s14.

In this manner, in one embodiment, if movement of the finger 500 toward an icon 405 has not been detected, the function of the icon 405 is not implemented. Therefore, the display 120 remains displaying the home screen 400.

In Step s14, if determination is made that the fingerprint authentication has succeeded and movement of the finger 500 toward an icon 405 has been detected during the lock mode, the controller 100 can implement the function of the icon 405 in accordance with the moving direction of the finger 500.

If fingerprint information is registered in the icon 405, the lock mode of the electronic apparatus 1 can be disabled and the function of the icon 405 can be implemented without moving away the finger 500. As a result, operability of the electronic apparatus 1 is enhanced.

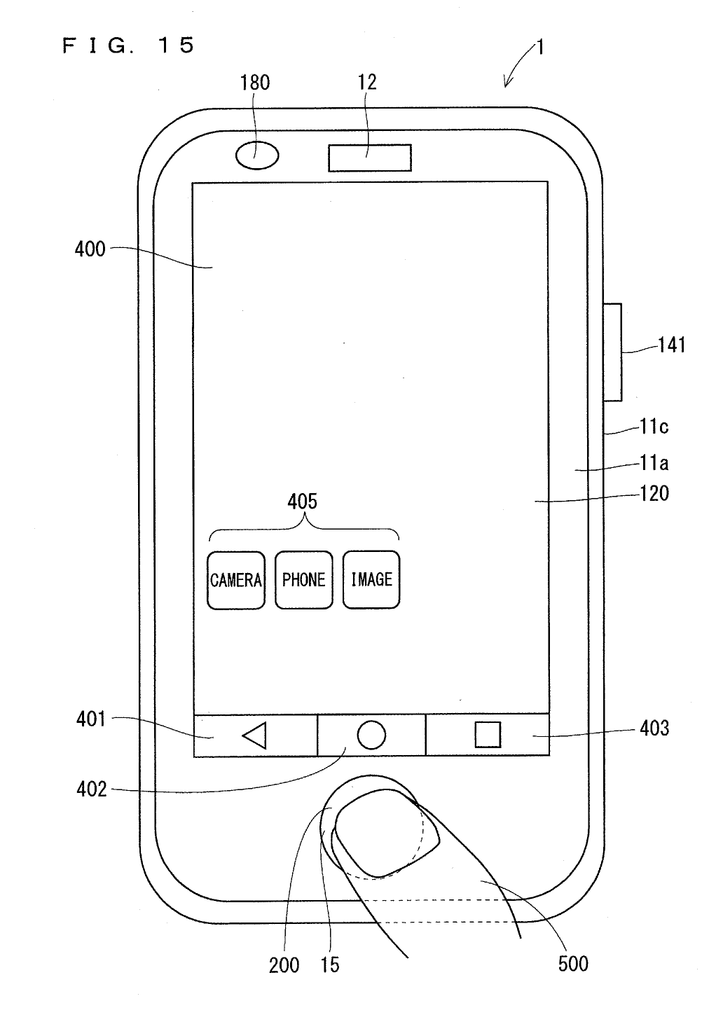

In one embodiment, the electronic apparatus 1 disables the lock mode and displays only icons 405, among the icons 405, that are associated with scanned fingerprint information. FIG. 15 illustrates a view showing a state of the electronic apparatus 1 in which fingerprint information is scanned by the fingerprint sensor 200 during the lock mode, and the mode is then transitioned to the unlocked mode where only icons 405 that are associated with the scanned fingerprint information are displayed.

The fingerprint authentication succeeds in Step s10. Then, the lock mode is disabled to set the unlocked mode, and only icons 405 that are associated with the scanned fingerprint information are displayed on the display 120. Displaying only icons 405 that are associated with the scanned fingerprint information on the display 120 comprises selecting icons 405 to be displayed based on the scanned fingerprint information and fingerprint information that is registered per icon 405. Further, displaying only icons 405 that are associated with the scanned fingerprint information on the display 120 comprises changing icons 405 to be displayed based on the scanned fingerprint information and the registered fingerprint information used to disable the lock mode.

Concerning the variation of the icons 405 to be displayed based on the scanned fingerprint information, for example, the icons 405 to be displayed may differ per fingerprint information of different fingers 500 of a single user. The icons 405 to be displayed may differ per fingerprint information of fingers 500 of a plurality of different users.

If the electronic apparatus 1 is shared by different users, one user can place restrictions for other users not to execute the functions of the icons 405 that are displayed only by fingerprint information of the user him/herself. As a result, operability of the electronic apparatus 1 is enhanced.

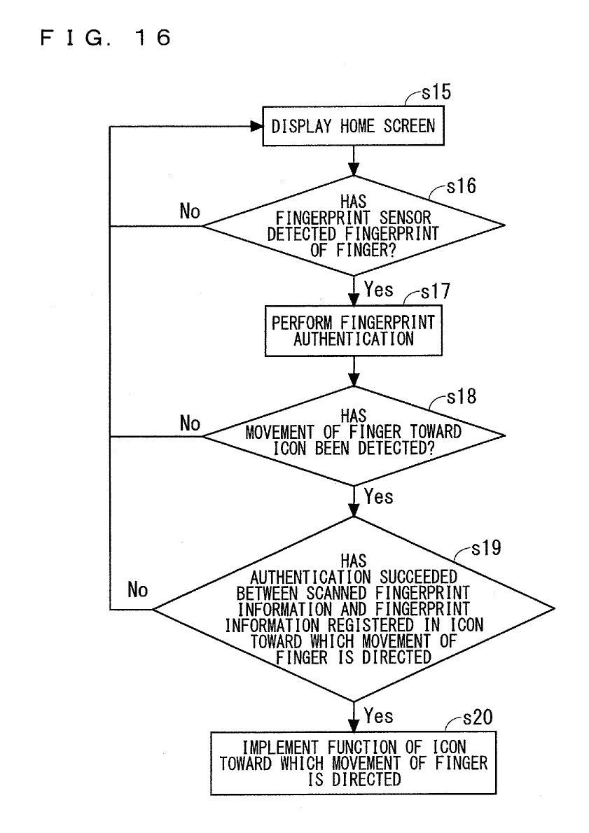

In one embodiment, the icon 405 comprises a first icon in which first fingerprint information is registered, and a second icon in which second fingerprint information that is different from the first fingerprint information is registered. The electronic apparatus 1 implements the function of the first icon if scanned fingerprint information matches the first fingerprint information and movement of the finger 500 is directed toward the first icon. The controller 100 does not implement the function of the second icon if scanned fingerprint information matches the first fingerprint information and movement of the finger 500 is directed toward the second icon. FIG. 16 illustrates a flowchart showing one example of operation of the electronic apparatus 1 that implements one function out of at least two icons 405 whose registered fingerprint information is different from each other.

In Step s15, the controller 100 displays the home screen 400 in the display 120. In Step s16, if determination is made that the finger 500 is in contact with the detecting surface 15 based on an output signal of the fingerprint sensor 200, Step s17 is executed. FIG. 7 illustrates a view in which the finger 500 is in contact with the detecting surface 15 when the home screen 400 is displayed.

In Step s17, the controller 100 performs fingerprint authentication based on fingerprint information scanned by the fingerprint sensor 200. After Step s17, the controller 100 determines in Step s18 whether or not movement of the finger 500 toward an icon 405 has been detected.

The controller 100 may detect movement of the finger 500 whose fingerprint information was scanned, using at least one of the fingerprint sensor 200 and the touch sensor 130. That is, after the fingerprint sensor 200 scans fingerprint information, the controller 100 may detect a moving direction of the finger 500 using only the fingerprint sensor 200. For example, if the fingerprint sensor 200 employs the electrostatic capacitance method, the controller 100 may make the fingerprint sensor 200 detect change in electrostatic capacitance that is caused by movement of the finger 500 on the detecting surface 15 after the fingerprint sensor 200 scans fingerprint information. The controller 100 may detect the moving direction of the finger 500 based on the change in electrostatic capacitance that is caused by the movement of the finger 500 on the detecting surface 15.

After the fingerprint sensor 200 scans fingerprint information, the controller 100 may detect the moving direction of the finger 500 whose fingerprint information was scanned, using only the touch sensor 130. For example, if the touch sensor 130 employs the electrostatic capacitance method, the controller 100 may make the touch sensor 130 detect change in electrostatic capacitance within a predetermined period of time since the fingerprint sensor 200 scanned the fingerprint information. If the touch sensor 130 detects change in electrostatic capacitance within a predetermined period of time since the fingerprint information was scanned, the controller 100 may attribute the change in electrostatic capacitance to the movement of the finger 500 whose fingerprint information was scanned. That is, the controller 100 may detect the moving direction of the finger 500 based on the change in electrostatic capacitance detected by the touch sensor 130 within a predetermined period of time since the fingerprint information was scanned.

After the fingerprint sensor 200 scans fingerprint information, the controller 100 may detect the moving direction of the finger 500 whose fingerprint information was scanned, using both of the fingerprint sensor 200 and the touch sensor 130. For example, if the fingerprint sensor 200 and the touch sensor 130 employ the electrostatic capacitance method, the controller 100 may detect change (hereinafter also referred to as first change) in electrostatic capacitance that is caused by movement of the finger 500 on the detecting surface 15 after the fingerprint sensor 200 scans fingerprint information. If the touch sensor 130 detects change (hereinafter also referred to as second change) in electrostatic capacitance within a predetermined period of time since the first change was detected, the controller 100 may attribute the first change and the second change to the movement of the finger 500 whose fingerprint information was scanned. That is, the controller 100 may detect the moving direction of the finger 500 based on the first change and the second change.

The movement of the finger 500 comprises flick, slide, swipe, and drag.

In Step s19, after movement of the finger 500 directed toward an icon 405 is detected, determination is made whether authentication has succeeded between the scanned fingerprint information and fingerprint information that is registered in the icon 405 toward which the movement of the finger 500 is directed.

After Step s18, the controller 100 determines in Step s19 whether or not authentication has succeeded between the scanned fingerprint information and the fingerprint information that is registered in the icon 405 toward which the movement of the finger 500 is directed. If determination is made in Step s19 that the fingerprint authentication has failed, in Step s20, the controller 100 does not implement the function of the icon 405 toward which the movement of the finger 500 is directed.

In this manner, in one embodiment, if the fingerprint authentication has failed, the function of the icon 405 toward which the movement of the finger 500 is directed is not implemented. Therefore, the display 120 remains displaying the home screen 400.

Note that, if the fingerprint authentication has failed, information notifying that the fingerprint authentication has failed may be displayed in the home screen 400. The user can easily know that the fingerprint authentication has failed because information notifying that the fingerprint authentication has failed is displayed in the case where fingerprint authentication has failed.

If the movement of the finger 500 toward an icon 405 has been detected and authentication has succeeded between the scanned fingerprint information and fingerprint information that is registered in the icon 405 toward which the movement of the finger 500 is directed, the controller 100 can implement the function of the icon 405 toward which the movement of the finger 500 is directed.

If the electronic apparatus 1 is shared by different users, one user can place restrictions for other users not to execute the functions of the icons 405 in which fingerprint information of the user him/herself is registered. As a result, operability of the electronic apparatus 1 is enhanced.

After Step s17, the controller 100 determines in Step s18 whether or not movement of the finger 500 toward an icon 405 has been detected. If determination is made in Step s18 that movement of the finger 500 toward an icon 405 has not been detected, the controller 100 does not implement the function of the icon 405 in Step s6.

In this manner, in one embodiment, if movement of the finger 500 toward an icon 405 has not been detected, the function of the icon 405 is not implemented. Therefore, the display 120 remains displaying the home screen 400.

In examples described above, the electronic apparatus 1 is a mobile phone such as a smartphone, but may be an electronic apparatus of other types. The electronic apparatus 1 may be, for example, a tablet terminal, a personal computer, or a wearable device. The wearable device acceptable as the electronic apparatus 1 may be of a type worn on the arm such as a wristband type or a wristwatch type, a type worn on the head such as a headband type or an eyeglass type, or a type worn on the body such as a clothing type.

While the electronic apparatus 1 has been described in detail, the foregoing description is in all aspects illustrative and not restrictive. Further, various examples described above can be applied in combination on the condition of being consistent. It is therefore understood that numerous unillustrated examples can be devised without departing from the scope of the present disclosure.

1. An electronic apparatus comprising:
a display configured to display at least one icon;
a fingerprint sensor configured to scan fingerprint information of a finger that is in contact with a detecting surface;
a touch sensor configured to detect contact of a finger; and
at least one processor configured to execute a function of a certain icon of the at least one icon based on the scanned fingerprint information and registered fingerprint information that is registered in advance if movement of a finger from the detecting surface toward the certain icon is detected.

2. The electronic apparatus according to claim 1, wherein the at least one processor restricts operation on the display while a finger is in contact with the detecting surface.

3. The electronic apparatus according to claim 1, wherein the at least one processor changes array order of the at least one icon to be displayed in the display if a finger comes in contact with the detecting surface.

4. The electronic apparatus according to claim 1, wherein the at least one processor makes the display show the at least one icon near the detecting surface if a finger comes in contact with the detecting surface.

5. The electronic apparatus according to claim 1, wherein the at least one processor executes the function if movement of a finger from the detecting surface toward the certain icon is detected and contact of the finger stops being detected on the certain icon.

6. The electronic apparatus according to claim 5, wherein the at least one processor executes the function if the finger is in contact with the certain icon for a predetermined period of time.

7. The electronic apparatus according to claim 1, wherein, during a lock mode, the at least one processor disables the lock mode based on the scanned fingerprint information and the registered fingerprint information that is registered in advance.

8. The electronic apparatus according to claim 7, wherein the at least one processor disables the lock mode and makes the display show only the at least one icon that is associated with the scanned fingerprint information.

9. The electronic apparatus according to claim 1, wherein
the at least one icon comprises a first icon that is associated with first fingerprint information, and a second icon that is associated with second fingerprint information that is different from the first fingerprint information,
the at least one processor executes a function of the first icon if the scanned fingerprint information matches the first fingerprint information and movement of the finger is directed toward the first icon, and
the at least one processor does not execute a function of the second icon if the scanned fingerprint information matches the first fingerprint information and movement of the finger is directed toward the second icon.
